(19) United States
(12) Patent Application Publication
(10) Pub. No.: US 2008/0030426 A1
(43) Pub. Date: Feb. 7, 2008

(54) INFORMATION PROCESSING APPARATUS AND DISPLAY CONTROL METHOD

(75) Inventor: Kazunari Hashimoto, Ome-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/771,851

(22) Filed: Jun. 29, 2007

(30) Foreign Application Priority Data
Jun. 30, 2006 (JP) 2006-182653

(51) Int. Cl. G09G 5/00

(52) U.S. Cl. 345/1.3

(57) ABSTRACT

According to one embodiment, an information processing apparatus, includes detection unit for detecting, if a display request for use of a plurality of display unit is made by a predetermined application, connection states of the display unit currently connected, a unit for conducting display to urge connection of a new display unit in accordance with the connection states of the display unit detector by the detection unit, initialization unit for initializing the display unit and the new display unit if the new display unit is connected after the display conducted by the unit for conducting the display to urge the connection of the new display unit, and a unit for displaying information on the display unit and the new display unit in accordance with the display request made by the application, after the initialization.

### CROSS-REFERENCE TO RELATED APPLICATIONS

This application is based upon and claims the benefit of priority from Japanese Patent Application No. 2006-182653, filed Jun. 30, 2006, the entire contents of which are incorporated herein by reference.

### BACKGROUND

1. Field

One embodiment of the invention relates to the present invention relates to a technique of displaying information on a plurality of connected display unit and, more particularly, to an information processing apparatus and a display control method capable of conducting different displays on the respective display unit by a single application.

2. Description of the Related Art

In a general system connecting with a plurality of display unit, there is a control technique as shown in, for example, JP-A No. 4-130921 (KOKAI) by which when a predetermined application starts, the display unit to be employed by the application is assigned and changed (cf. JP-A No. 4-130921 (KOKAI)).

However, this technique does not correspond to control of simultaneously conducting different displays on a plurality of display unit serving as multimonitors, by a single application. The technique needs to be set manually and the setting is complicated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outer appearance of an information processing apparatus according to an embodiment of the present application;

FIG. 2 is an exemplary block diagram showing main portions of the information processing apparatus according to the embodiment;

FIG. 3 is an exemplary flowchart of a display control method to which the information processing apparatus is applied according to the embodiment;

FIG. 4 is an exemplary illustration of an example of a screen displayed in a case where a new display unit is connected according to the embodiment; and

FIG. 5 is an exemplary illustration of an example of a screen displayed in a case where changing to a multimonitor is confirmed according to the embodiment.

### DETAILED DESCRIPTION

Various embodiments according to the invention will be described hereinafter with reference to the accompanying drawings. In general, according to one embodiment of the invention, an information processing apparatus, comprises: detection means for detecting, if a display request for use of a plurality of display units is made by a predetermined application, connection states of the display units currently connected; means for conducting display to urge connection of a new display unit in accordance with the connection states of the display units detected by the detection means; initialization means for initializing the display units and the new display unit if the new display unit is connected after the display conducted by the means for conducting the display to urge the connection of the new display unit; and display means for displaying information on the display units and the new display unit in accordance with the display request made by the application, after the initialization of the initialization means.

An embodiment of the present invention will be described below with reference to the accompanying drawings.

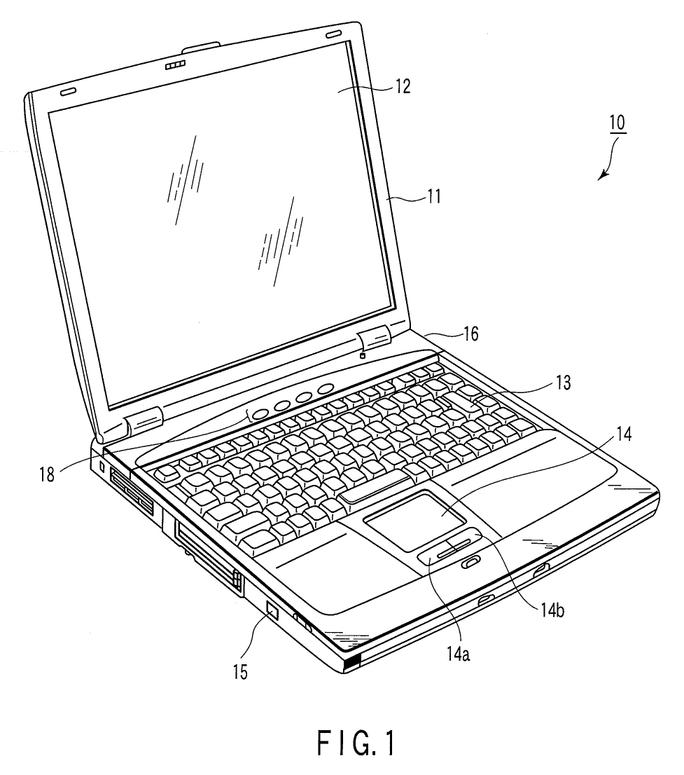

FIG. 1 is a perspective view showing an information processing apparatus according to the embodiment of the present invention. The information processing apparatus is implemented as a battery-operated notebook computer 10.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b, various kinds of shortcut buttons for mail, a power button 18 and the like on a palm rest. An optical drive 15 is provided on a side face of the main body 16.

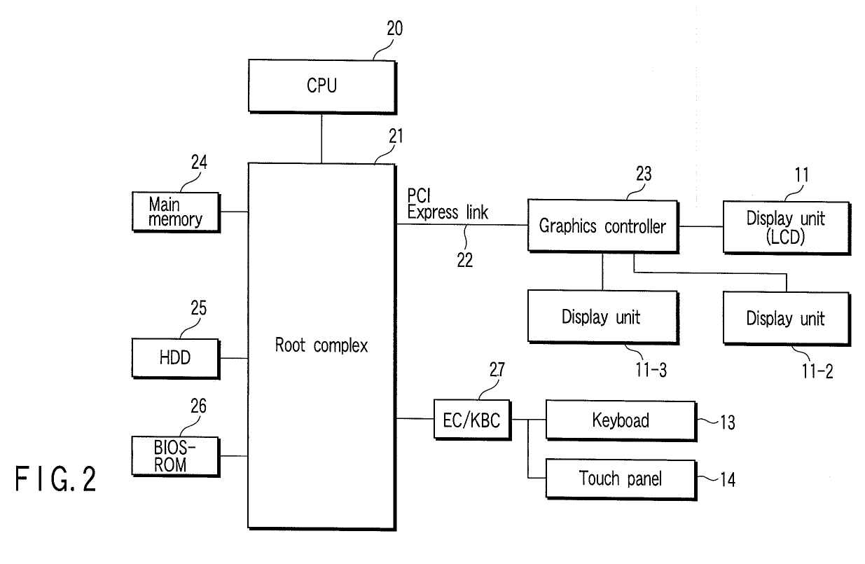

FIG. 2 is a block diagram showing main units of the information processing apparatus according to the embodiment of the present invention.

The computer 10 comprises a CPU (Central Processing Unit) 20, a Root Complex 21, a main memory 24, a graphics controller (End Point) 23, a PCI Express Link 22 making a connection between the Root Complex 21 and the graphics controller 23, the display unit 11 serving as a display (LCD), display units 11-2, 11-3 of external connection such as TV, DVI (Digital Visual Interface), HDMI (High-Definition Multimedia Interface), etc., an embedded controller/keyboard controller IC (EC/KBC) 27, a hard disk drive (HDD) 25, a BIOS-ROM 26, the keyboard 13, the touch pad 14, and the like.

The Root Complex 21, the graphics controller 23 and the like are devices in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor controlling the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller configured to control display units 11 to 11-3 to be employed as display monitors of the computer.

The EC/KBC 27 is a one-chip microcomputer on which an embedded controller for power management and a keyboard controller controlling the keyboard 13 and the touch pad 14 are integrated. The EC/KBC 27 has a function of controlling power-on/power-off of the computer 10, in cooperation with a power supply controller, in response to the user's operation of the power button.

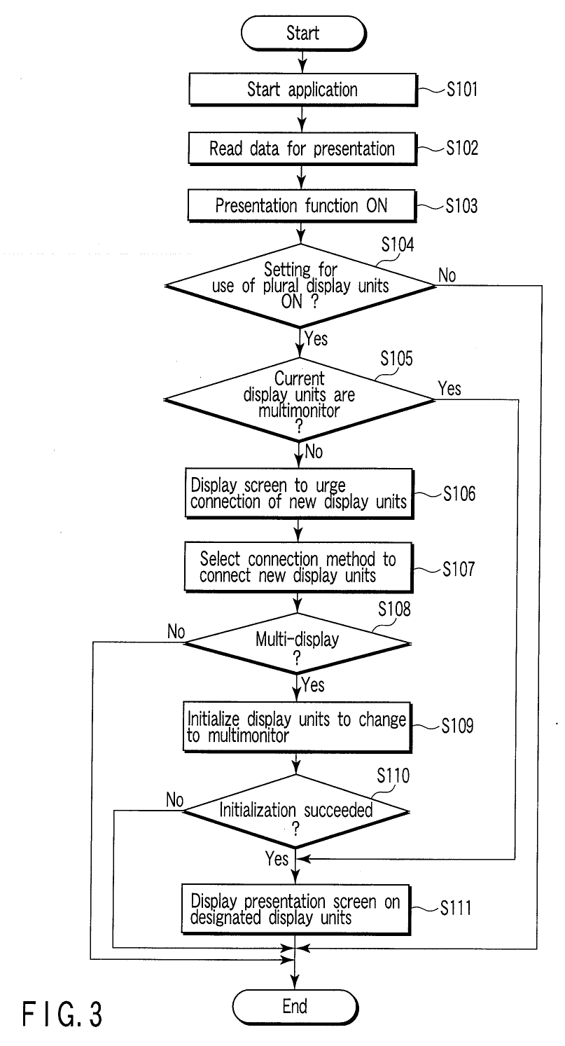

Next, a display control method of the information processing apparatus according to the present invention is described with reference to a flowchart of FIG. 3. In the present embodiment, a presentation application is described as a predetermined application. However, the predetermined application is not limited to this, but may be adaptable to a multimonitor.

The CPU 20 loads and starts a predetermined application, for example, a presentation application on the main memory 24 from the HDD 25 (block S101). When the presentation application reads data (files) for presentation (block S102), a presentation function of the presentation application is ON (block S103).

The CPU 20 discriminates whether or not a setting of employing a plurality of display units (multimonitor function) is ON. The CPU 20 discriminates the multimonitor function by discriminating whether or not, for example, a flag of the setting of the presentation application is ON (block S104). Alternatively, a flag may be embedded in the data (files) for presentation and confirmed. When the CPU 20 discriminates in block S104 that the setting of employing a plurality of display units (multimonitor function) is ON (block S105), the CPU 20 discriminates whether or not currently connected display units function as the multimonitor (block S105).

The CPU 20 can conduct this discrimination by making an inquiry to API (Application Program Interface).

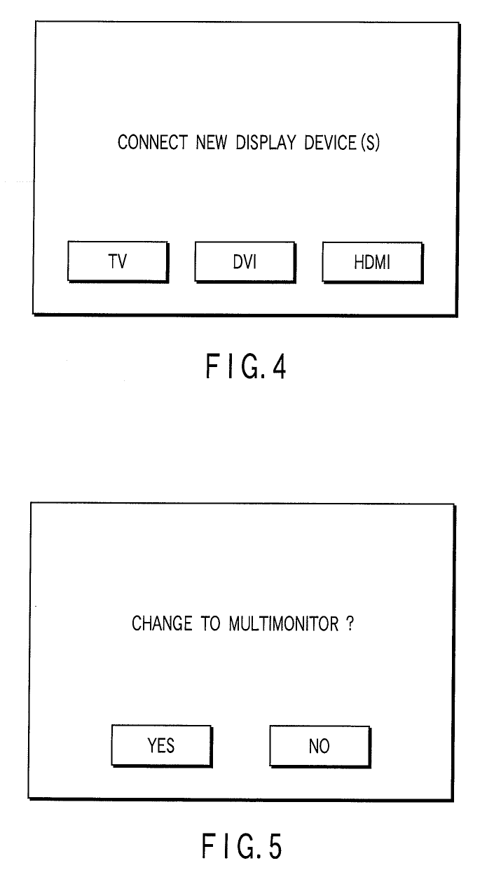

When it is discriminated in block S105 by the CPU 20 that the connected display units do not function as the multimonitor, the CPU 20 urges the LCD 11 to display a screen to promote connection of new display units as shown in, for example, FIG. 4 (block S106), the CPU 20 further urges the LCD 11 to display a method of connecting new display units (block S107). As shown in FIG. 4, for example, the LCD 11 displays selectable buttons concerning output to TV, output to a DVI-mode monitor (for example, projector), output to a HDMI-mode monitor, and the like.

Next, when the CPU 20 confirms that the predetermined display units have been connected, the CPU 20 displays a selection screen indicating whether or not displaying should be conducted by the multimonitor and urges the selection indicating whether or not displaying should be conducted by the multimonitor as shown in, for example, FIG. 5 (block S108). If displaying by the multimonitor is selected (for example, YES button on the screen is pushed down: YES in block S108), the CPU 20 sends a display request of multimonitor (including an initialization request) to the graphics controller 23 and conducts initialization of each of the display units 11 to 11-3 to be employed as the multimonitor, in order to change the display unit to the multimonitor (block S109). If it is discriminated by the CPU 20 that the initialization is successfully conducted (YES in block S110), the CPU 20 displays the presentation screen on designated display units, for example, display units 11 to 11-3, in accordance with the above display request (block S111). At this time, for example, an operation panel is displayed on the computer 10 serving as the display unit 11 while the presentation screen is displayed on the two display units 11-2 and 11-3.

On the other hand, if it is discriminated by the CPU 20 in block S104 that the flag of setting of the presentation application is not ON, the display control is ended (NO in block S104). Moreover, if it is discriminated by the CPU 20 in block S105 that the setting of using a plurality of display units (multimonitor function) is ON, the operation shifts to block S111 to display the presentation screen and the like on each of the display units 11 to 11-3 as described above.

As described above, when a plurality of display units simultaneously conduct different displays as the multimonitor by the single application, you can unconsciously support the change of the display mode and easily conduct the displays, by employing the embodiment of the present application.

In addition, for example, if use of a plurality of display units is set on the application side (i.e. if the multimonitor function is set to be ON), the user can easily prepare a plurality of display units by merely starting the application, change the display units to the multimonitor and display data on external display devices.

Furthermore, the present invention can be assigned a function of designating the resolution when the display units are changed to the multimonitor on the application side by the CPU 20. In this case, the CPU 20 preliminarily obtains optimum resolution modes from the display units 11 to 11-3 and sends the display request to the graphics controller 23 together with the display request for change to the multimonitor. In other words, when the display units are changed to the multimonitor on the application side by the CPU 20, the optimum resolution can be designated for each of the monitors. Thus, the present invention can be assigned a function of obtaining the optimum resolution (generally called preferred mode) of each of the display units from the monitor and changing the resolution to the optimum resolution when the types of the display units to display the presentation are unknown.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
detection means for detecting the connection state of a first display unit when a request for the use of at least one new display unit is made by a predetermined application;
means for urging a display to promote connection of the new display unit in accordance with the connection state of the first display unit detected by the detection means;
initialization means for initializing the first display unit and the new display unit when the new display unit is connected; and
display means for displaying information on the first display unit and the new display unit in accordance with the display request made by the application after the initialization of the first display unit and new display unit.

2. The apparatus according to claim 1, wherein the means for urging the display to promote the connection urges the display to promote connection of a necessary number of new display units meeting the display request for use of the at least one new display unit made by the application.

3. The apparatus according to claim 1, wherein the means for urging the display to promote the connection promotes the display of a connection mode of the new display unit, besides the display to promote the connection of the new display unit.

4. The apparatus according to claim 1, wherein the display request for use of the at least one new display unit made by the application is flag information set in the application.

5. The apparatus according to claim 1, wherein the display request for use of the at least one new display unit made by the application is flag information set in data which are read by the application.

6. The apparatus according to claim 4, wherein the display request for use of the at least one new display unit made by the application includes resolution information for designation of resolutions of the first display unit and the new display unit.

7. The apparatus according to claim 5, wherein the display request for use of the at least one new display unit made by the application includes resolution information for designation of resolutions of the first display unit and the new display unit.

8. The apparatus according to claim 6, wherein the resolution information is optimum resolution information obtained from the first display unit and the new display unit by the application.

9. A display control method, comprising:
detecting, when a display request for use of a plurality of display units is made by a predetermined application, connection states of a display unit currently connected;
urging a display to promote connection of a new display unit in accordance with the connection states of the display unit;
initializing the display unit and the new display unit if the new display unit is connected after the display to promote the connection is urged; and
displaying information on the display unit and the new display unit in accordance with the display request made by the application, after the initialization.

10. The method according to claim 9, wherein the urging the display to promote connection urges the display to promote connection of a necessary number of new display units meeting the display request for use of the plurality of display units made by the application.

11. The method according to claim 9, wherein urging the display to promote connection urges the display of a connection mode of the new display unit, besides the display to promote connection of the new display unit.

12. The method according to claim 9, wherein the display request for use of the plurality of display units made by the application is flag information set in the application.

13. The method according to claim 9, wherein the display request for use of the plurality of display units made by the application is flag information set in data which are read by the application.
